(19) United States
(12) Patent Application Publication
(10) Pub. No.: US 2026/0093489 A1
(43) Pub. Date: Apr. 2, 2026

(54) VECTOR FLOATING-POINT FLAG UPDATE WITH MICRO-OPERATIONS

(71) Applicant: Akeana, Inc., Santa Clara, CA (US)

(72) Inventors: Abhijit Sil, Dublin, CA (US); Ricardo Ramirez, Sunnyvale, CA (US)

(73) Assignee: Akeana, Inc., Santa Clara, CA (US)

(21) Appl. No.: 19/386,465

(22) Filed: Nov. 12, 2025

Related U.S. Application Data
(63) Continuation-in-part of application No. 19/374,321, filed on Oct. 30, 2025.
Application No. 19/374,321 is a continuation-in-part of application No. 19/342,743, filed on Sep. 29, 2025.
Application No. 19/342,743 is a continuation-in-part of application No. 19/290,518, filed on Aug. 5, 2025.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.

(51) Int. Cl. G06F 9/30; G06F 9/38

(52) U.S. Cl. CPC G06F 9/30036; G06F 9/3856

(57) ABSTRACT

A processor core is coupled to a memory hierarchy. The processor core is configured to execute vector floating-point instructions and micro-operations. A vector floating-point instruction is decoded. The decoding includes replacing the vector floating-point instruction with one or more vector floating-point micro-operations (VFPMs). A reorder buffer assigns a reorder buffer ID (ROBID) to each of the one or more VFPMs, in which the assigning includes a micro-sequencer ID (MSID). The processor core executes the one or more VFPMs. The executing includes requiring, by a first VFPM within the one or more VFPMs, a first update to an architectural floating-point flag. The architectural floating-point flag is set, based on the first update. The setting occurs after the one or more VFPMs have been committed by the processor core. A temporary floating-point flag is revised. The revising is based on the first update.

### RELATED APPLICATIONS

This application claims the benefit of U.S. provisional patent applications “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, and “Matrix Multiply Acceleration Based On A Static Partitioning History Table”Ser. No. 63/914,824, filed November, 10, 2025.

This application is also a continuation-in-part of U.S. patent application “Non-Blocking Vector Instruction Dispatch With Micro-Element Operations” Ser. No. 19/374,321, filed Oct. 30, 2025, which claims the benefit of U.S. provisional patent applications “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, and “Invalidating Snoop Avoidance With Multiple Atomic Loops” Ser. No. 63/899,591, filed Oct. 15, 2025.

The U.S. patent application “Non-Blocking Vector Instruction Dispatch With Micro-Element Operations” Ser. No. 19/374,321, filed Oct. 30, 2025 is also a continuation-in-part of U.S. patent application “Non-Blocking Unit Stride Vector Instruction Dispatch With Micro-Operations” Ser. No. 19/342,743, filed Sep. 29, 2025, which claims the benefit of U.S. provisional patent applications “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, and “In-Order Multithreading With Pipeline Flush And Instruction Replay”Ser. No. 63/870,916, filed Aug. 27, 2025.

The U.S. patent application “Non-Blocking Unit Stride Vector Instruction Dispatch With Micro-Operations” Ser. No. 19/342,743, filed Sep. 29, 2025, is also a continuation-in-part of U.S. patent application “Non-Blocking Vector Instruction Dispatch With Micro-Operations” Ser. No. 19/290,518, filed Aug. 5, 2025, which claims the benefit of U.S. provisional patent applications “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, and “AI Compute Clusters With Noncoherent Shared SRAM” Ser. No. 63/854,877, filed Jul. 31, 2025.

Each of the foregoing applications is hereby incorporated by reference in its entirety.

### FIELD OF ART

This application relates generally to vector processing and more particularly to a vector floating-point flag update with micro-operations.

### BACKGROUND

High-performance processors can execute instructions at a high rate, leading to quicker data processing. This results in reduced application load times and faster response rates, which are essential for tasks like gaming, video editing, and 3D rendering. Additionally, tasks such as artificial intelligence (AI), machine learning, and data analytics require significant computational power. High-performance processors can handle these complex workloads, making them suitable for AI-driven applications, real-time analytics, and simulations. The high-performance processes can be used to accelerate the training of complex models used in machine learning and artificial intelligence, such as for image recognition, natural language processing, and autonomous driving. The high-performance processors can be used to model complex weather patterns, predict climate change, and run simulations for natural disaster prediction (e.g., hurricanes, earthquakes). Furthermore, for real-time applications like autonomous vehicles, financial trading systems, and industrial automation, high-performance processors provide the low-latency performance necessary to meet strict time constraints.

RISC (Reduced Instruction Set Computer) processors are high-performance processors designed with simplicity and efficiency in mind, focusing on a smaller set of simple, general-purpose instructions that can be executed very quickly. This design philosophy stands in contrast to Complex Instruction Set Computer (CISC) processors, which use more complex and specialized instructions. RISC processors separate memory access from computation. Load and store instructions can access memory, while other instructions operate on registers. Moreover, RISC processors can include a large number of general-purpose registers. This minimizes the need to access slower memory, as more operations can be performed directly in the registers.

RISC processors are used in a wide variety of applications. One popular application of RISC processors is for use in mobile devices such as smartphones and tablet computers, due to the low power consumption and high performance that RISC processors can provide. Another growing application is Internet of Things (IoT) devices. Internet of Things (IoT) devices can use RISC architectures to handle computational tasks while maintaining low power consumption. IoT technology has greatly impacted areas such as home automation, wearable devices, healthcare, retail, and others. IoT applications span multiple sectors, transforming homes, industries, healthcare, agriculture, and cities into more efficient, automated, and data-driven environments. Each application leverages IoT capability to collect and act on real-time data, providing benefits such as improved efficiency, enhanced user experiences, and smarter resource management. Other applications of RISC processors can include embedded systems, supercomputing, and artificial intelligence, to name a few.

High-performance processors provide greater computational capabilities, support complex tasks, enable efficient power management, and improve overall user experience across diverse devices, from mobile phones to supercomputers. While today's processors are incredibly powerful and are capable of handling many modern computing needs, there is still a strong need for continued improvements in processor performance to meet the demands of future applications. RISC processors can provide a small and efficient instruction set, load/store architecture, simple addressing modes, large register sets, and heavy use of pipelining. These features allow RISC architectures to offer high performance, energy efficiency, and scalability, making them ideal for a wide range of applications, from embedded systems to high-performance computing.

### SUMMARY

Vector Floating-Point (VFP) operations are critical in modern processors, particularly for tasks involving mathematical computations, scientific simulations, and multimedia processing. Floating-point numbers allow for greater precision, which is crucial in applications that require a high degree of accuracy such as scientific simulations or financial modeling. Vectorized floating-point operations can ensure both high performance and precision when working with complex datasets. Moreover, VFP operations play a critical role in processing the complex mathematical calculations involved in 3D rendering, ray tracing, and computer graphics. Modern gaming engines use VFP operations for real-time physics simulations and AI-driven behaviors.

A processor core is coupled to a memory hierarchy. The processor core is configured to execute vector floating-point instructions and micro-operations. A vector floating-point instruction is decoded. The decoding includes replacing the vector floating-point instruction with one or more vector floating-point micro-operations (VFPMs). A reorder buffer assigns a reorder buffer ID (ROBID) to each of the one or more VFPMs, in which the assigning includes a micro-sequencer ID (MSID). The processor core executes the one or more VFPMs.

The executing includes requiring, by a first VFPM within the one or more VFPMs, a first update to an architectural floating-point flag. The architectural floating-point flag is set, based on the first update. The setting occurs after the one or more VFPMs have been committed by the processor core. A temporary floating-point flag is revised. The revising is based on the first update.

A processor-implemented method for vector processing is disclosed comprising: accessing a processor core, wherein the processor core is coupled to a memory hierarchy, and wherein the processor core is configured to execute vector floating-point instructions and micro-operations; decoding a vector floating-point instruction, wherein the decoding includes replacing the vector floating-point instruction with one or more vector floating-point micro-operations (VFPMs); assigning, by a reorder buffer (ROB), a reorder buffer ID (ROBID) to each of the one or more VFPMs, wherein the assigning includes a micro-sequencer ID (MSID); executing, by the processor core, the one or more VFPMs, wherein the executing includes requiring, by a first VFPM within the one or more VFPMs, a first update to an architectural floating-point flag; and setting the architectural floating-point flag, wherein the setting is based on the first update, and wherein the setting occurs after the one or more VFPMs have been committed by the processor core. In embodiments, the setting includes revising a temporary floating-point flag, wherein the revising is based on the first update. In embodiments, the setting includes copying the temporary floating-point flag to the architectural floating-point flag. Some embodiments comprise checking, within the ROB, for availability of the one or more VFPMs, wherein the assigning is based on the checking.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a vector floating-point flag update with micro-operations.

FIG. 2 is a flow diagram for updating flags.

FIG. 3 is an infographic for a vector floating-point flag update with micro-operations.

FIG. 4 is a block diagram of a multicore processor.

FIG. 5 is a block diagram of a pipeline.

FIG. 6 is a block diagram for a vector floating-point flag update with micro-operations.

FIG. 7 is an example of copying flag updates.

FIG. 8 is a system diagram for a vector floating-point flag update with micro-operations.

### DETAILED DESCRIPTION

Vector Floating-Point (VFP) operations are important extensions to modern computer processors. These processors can include pipelines that can handle the vector floating-point operations, which can be separated into micro-operations for execution. Efficient pipelines can allow multiple micro-operations to run concurrently, increasing instruction throughput. By dividing execution into stages, each stage can be optimized for specific tasks, speeding up processing. Use of a pipeline, or “pipelining,” reduces the time it takes to execute a series of micro-operations by providing the micro-operations to the pipeline. This technique enables the processor to initiate processing of a next operation before the previous operation has completed. Shortening the execution time of individual operations translates to faster overall program execution. The increased processor performance attributable to sequencing of the micro-operations can occur when an operation exploits instruction-level parallelism (ILP). The ILP enables multiple instructions or operations to be in various stages of execution simultaneously. Furthermore, efficient pipelines help maintain a steady flow of operations through the processor, reducing the likelihood of operation stalls or bottlenecks. A seamless operation flow ensures that the processor can consistently perform at or near its peak capabilities.

Instruction sets can include scalar instructions and vector instructions. Scalar instructions may operate on individual data points and may use general-purpose registers for data storage. Scalar instructions are often used in branching and control instructions as well as integer operations. Vector instructions/operations can operate on multiple data elements simultaneously. Vector instructions may utilize dedicated vector registers, allowing for operations on entire arrays. Vector instructions can serve to increase throughput by performing the same operation across datasets with fewer instructions. Extensions such as vector floating-point operation extensions can be enabled for a processor architecture such as a RISC-V processor core. Vector floating-point operations can, with a single instruction, require many individual operations to complete the single instruction. For example, vector floating-point operations such as vector addition, vector subtraction, vector multiplication, vector division, dot product, vector square root, vector reciprocal, vector fused multiply-add (FMA), vector magnitude, vector reduction, 3D vector cross product, and others can involve several steps and complex operations to accurately compute the result of the vector floating-point operation.

While vector floating-point operations have utility in many applications, the nature of floating-point mathematical operations requires handling of various errors and/or corner cases. During floating-point operations, various computational errors can occur due to the limitations of representing real numbers in a finite number of bits. These errors typically manifest as special conditions or exceptions. These can include results such as NaN (Not a Number). NaN represents an undefined or unrepresentable result. It can occur when an operation does not yield a meaningful numerical result. Examples of such operations can include division by zero, attempting to compute a square root of a negative number, and operations involving NaN as an operand (e.g., NaN+5). Any operation involving NaN will result in NaN propagating through the computation, signaling that something went wrong in the calculation. Another error can be an overflow. Overflow can occur when a floating-point operation results in a value that is too large to be represented within the range of the floating-point format (e.g., exceeding the maximum allowable value). Causes can include operations resulting in extremely large numbers, such as multiplying very large numbers together, and/or computing exponential functions with large input values. Overflow can lead to a loss of precision and can cause incorrect results in subsequent operations. Another error can be underflow. Underflow can occur when a floating-point operation results in a value that is too small (close to zero) to be represented in the normalized range of the floating-point format. Examples of such operations can include multiplying very small numbers together, and/or subtraction of nearly equal numbers. The result can be represented as a zero or a denormalized number having reduced precision. Underflow can lead to a loss of precision, and in some cases, important information can be lost if the result is zero when it should be a very small number. These, and other floating-point exception conditions, can further complicate the use of micro-operations to implement vector floating-point instructions, as such exceptions can occur in one or more micro-operations of a vector floating-point instruction.

When a floating-point exception occurs during the execution of a floating-point operation, both the processor and software can take several possible actions, depending on the architecture, operating system, and how the program is configured to handle these exceptions. Floating-point exceptions can occur due to various conditions such as division by zero, overflow, underflow, or invalid operations like taking the square root of a negative number. Mitigation actions can include, but are not limited to, raising an exception, returning a special value (e.g., NaN), aborting execution, or ignoring the exception and continuing execution.

Disclosed techniques enable vector floating-point operations with flag updating and micro-operations. A processor core is coupled to a memory hierarchy. The processor core is configured to execute vector floating-point instructions and micro-operations. A vector floating-point instruction is decoded. The decoding includes replacing the vector floating-point instruction with one or more vector floating-point micro-operations (VFPMs). A reorder buffer assigns a reorder buffer ID (ROBID) to each of the one or more VFPMs, in which the assigning includes a micro-sequencer ID (MSID). The processor core executes the one or more VFPMs, where the executing includes requiring, by a first VFPM within the one or more VFPMs, a first update to an architectural floating-point flag. The architectural floating-point flag is set, based on the first update, where the setting occurs after the one or more VFPMs have been committed by the processor core. In this way, exemplary implementations ensure that floating-point exceptions and/or errors are made available to software executing on the processor core, while still providing the benefits of micro-operations for implementation of vector floating-point instructions.

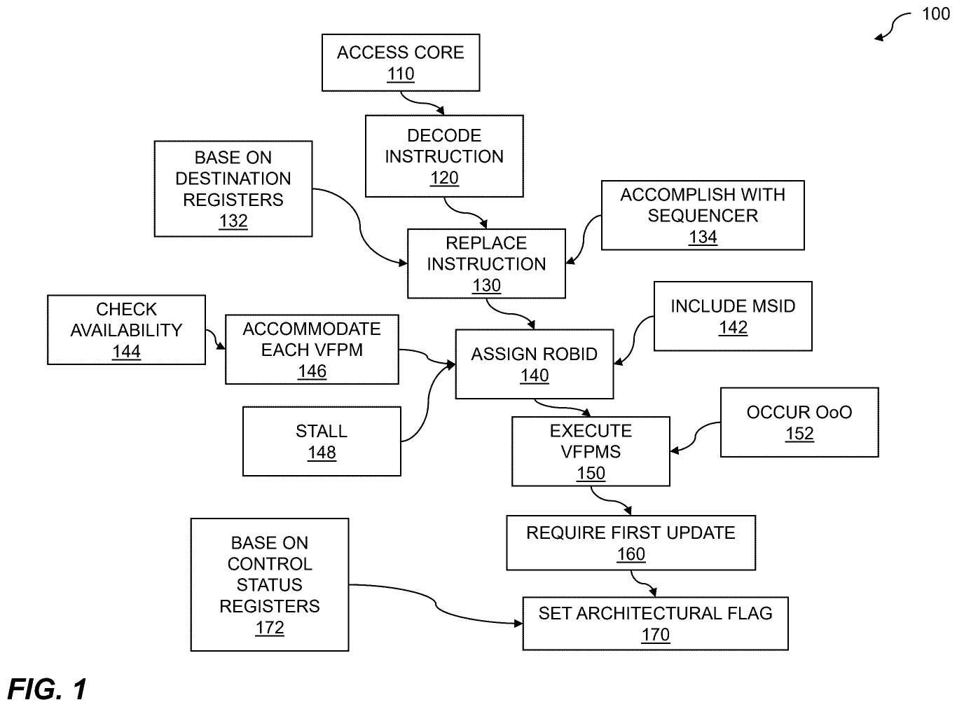

FIG. 1 is a flow diagram for a vector floating-point flag update with micro-operations. The flow 100 includes accessing a processor core 110. The processor core can be included on a multi-processor chip, an application specific integrated circuit (ASIC), a system-on-a-chip (SOC), and so on. The processor core can execute instructions that are part of an instruction set architecture (ISA) such as X86, ARM, and so on. The processor core is coupled to a memory hierarchy. The memory hierarchy can include L1, L2, L3, etc. caches. The memory hierarchy can include memory such as DRAM, SDRAM, and so on. The memory hierarchy can be coherent or non-coherent. In embodiments, the processor core is configured to execute vector instructions, scalar instructions, and micro-operations. The micro-operations can comprise a series of instructions that can take the place of a single, more complex instruction.

The micro-operation sequencer can be used for vector instructions, scalar instructions, floating point instructions, and so on. Vector instructions can be executed by the processor within a vector pipeline, while scalar instructions can be executed by a scalar pipeline. In some situations, instructions can be executed in different pipelines. For example, a vector load or store instruction associated with a unit stride memory addressing mode can be executed in a scalar load pipeline. Other possibilities can exist for vector operations to be executed in non-vector pipelines and vice versa.

The vector instructions can include vector floating-point (VFP) instructions. The VFP can include, but are not limited to, addition, subtraction, multiplication, and division.

Additionally, the VFP can include fused multiply-add (FMA) operations. Fused multiply-add instructions are beneficial for optimizing floating-point arithmetic by combining multiplication and addition into a single operation, reducing rounding errors and improving performance. In exemplary implementations, the FMA operations can include multiplying elements of two vectors and adding the result to elements from a third vector, all in one operation. In exemplary implementations, the FMA operations can further include a fused multiply-subtract operation which multiplies elements of two vectors and subtracts the result from elements of a third vector. The VFP instructions can include reduction operations that provide a scalar result based on floating-point vector values. In exemplary implementations, the reduction operations can include a reduction sum operation, which sums all elements of a floating-point vector and produces a scalar result. Exemplary implementations can further include a reduction minimum operation which returns the minimum value across all elements of a floating-point vector. Exemplary implementations can further include a reduction maximum operation which returns the maximum value across all elements of a floating-point vector. Other VFP operations can include a vector floating-point square root operation that computes a square root of each element in a floating-point vector. Other VFP operations can include a vector floating-point reciprocal operation that computes an approximate reciprocal of each element in a floating-point vector. Other VFP operations can include floating-point comparison operations, such as a “less than” operation and an equal operation. These instructions compare elements of two floating-point vectors and produce a Boolean result (true or false) for each element. Other VFP operations are possible in exemplary implementations. For example, the RISC-V Vector Extension (RVV) introduces a wide range of vector floating-point instructions that allow for high-performance parallel processing in tasks such as scientific computation, machine learning, and real-time data processing. These instructions allow for element-wise arithmetic, reduction operations, floating-point comparisons, conversions, and more, enabling efficient handling of large datasets. Embodiments can include accessing a processor core. The processor core can include a RISC-V core, MIPS core, ARM core, and so on. In embodiments the processor core is coupled to a memory hierarchy. The memory hierarchy can include multiple cache levels, memory, and/or other storage technologies. In embodiments, the processor core is configured to execute vector floating-point instructions and micro-operations.

The flow 100 continues with decoding a vector floating-point instruction 120. The instruction can include a scalar instruction and/or a vector instruction. The decoding can include identifying opcodes, operands, control signals, and the like. The opcodes can include vector floating-point instruction opcodes. The decoding can be accomplished by a decode unit and/or a decode stage within a processor core. A floating-point vector instruction, such as those mentioned previously, can be fetched from memory and decoded by the processor core. Thus, embodiments include decoding a vector floating-point instruction. The decoding includes replacing the vector floating-point instruction with one or more vector floating-point micro-operations (VFPMs) 130. The replacing can be based on one or more destination registers 132. In embodiments, the decoding includes replacing the vector floating-point instruction with one or more vector floating-point micro-operations (VFPMs). The vector floating-point instruction can operate on one or more destination registers. In embodiments, the vector floating-point instruction is associated with a vector length multiplier (VLM), wherein each destination register of the one or more VFPMs is based on the VLM. The destination register can be determined by a combination of the VLM and other control registers such as a selected element width (SEW), which can define a vector element width as a control register, and an effective element width (EEW), which can define a vector element width within an instruction opcode. A combination of VLM, EEW, and SEW can define one or more destination registers that are operated on by the single vector floating-point instruction. Thus, in embodiments, the replacing is based on the one or more destination registers.

The replacing can be accomplished with a sequencer 134. Micro-operations can improve processor performance, such as processor performance when executing vector instructions, by preventing pipeline stalls. While the pipelining in RISC architectures can improve performance, a mix of scalar and vector instructions (including vector instructions that have been divided into multiple vector micro-operations) can create stalls in a processor pipeline. Pipeline stalls lead to a reduction in the overall instruction throughput, slowing down program execution. Each stalled cycle adds latency, delaying the completion of instructions. Moreover, pipeline stages are left idle during stalls, leading to inefficient use of CPU resources. In particular, since a vector instruction can be more complex (and thus can take longer to process) than a scalar instruction, processing of a vector instruction in the dispatch stage could potentially create a situation where scalar instructions are waiting to enter the pipeline, causing a bottleneck. Vector instruction complexity can be related to the number of data elements they can operate on at once. Disclosures can handle that complexity by splitting a vector instruction into multiple instructions via a micro-sequencer. In embodiments, the replacing is accomplished by a micro-operation sequencer.

The flow 100 continues with assigning, by a reorder buffer (ROB), a reorder buffer ID (ROBID) 140 to each of the one or more VFPMs. A ROBID can be used to ensure that all instructions are retired in order while still supporting out-of-order (OoO) execution. In one or more implementations, a dispatch stage can maintain a reorder buffer (ROB) that can indicate an arrival order of an instruction in the dispatch stage. An execution stage can follow the dispatch stage. The ROB can be used to ensure proper sequencing, committing, and retiring of instructions. The retiring can include successfully completing the execution and writing of results of the instruction back to a register file, memory, and so on. Upon retirement, the instruction can be removed from the pipeline. The dispatch unit can maintain a ROBID that is used to ensure that instructions are completed in the correct program order, while still supporting an out-of-order instruction architecture. The assigning includes a micro-sequencer ID (MSID) 142. The MSID can be the ROBID of a last VFPM within the one or more VFPMs that correspond to the vector floating-point instruction. The MSID can be any other value that is similar across all of the VFPMs. The MSID can be used to accumulate flag updates before committing the last VFPM within the one or more VFPMs.

The flow 100 can include checking availability 144. One or more embodiments can include checking, within the ROB, for availability for the one or more VFPMs, wherein the assigning is based on the checking. A ROB can include a predetermined number of slots for micro-operations. In exemplary implementations, a vector floating-point operation is divided into one or more micro-operations, where each of the one or more micro-operations is input to an available slot in the ROB. In one or more exemplary implementations, a ROB slot can be associated with a bit to indicate whether the entry is full or empty (available). The flow 100 can include accommodating each VFPM 146. In exemplary implementations, available slots must exist for all VFPMs corresponding to that vector floating-point instruction before any micro-operations are sent to the ROB. Since all VFPMs can be executed to achieve the same result as the original vector floating-point instruction, they must all be handled as a group within the pipeline. That is, they must all complete together in order for software to obtain the correct architectural state at all times. Thus, in embodiments, the availability accommodates each VFPM in the one or more VFPMs. In the event that there are not sufficient ROB slots available for each VFPM of the vector floating-point instruction, the flow 100 can include stalling 148, in which case the pipeline can stall until sufficient ROB slots are free. In one or more embodiments, the availability does not accommodate each VFPM in the one or more VFPMs. Thus, embodiments can include stalling the assigning of the one or more VFPMs.

The flow 100 continues with executing, by the processor core, the one or more VFPMs 150. As described above, a vector floating-point instruction can be executed by splitting the vector floating-point instruction into a series of micro-operations and initiating execution of the series of micro-operations. Once a ROBID and an MSID are obtained for each VFPM, the vector floating-point instruction can be enqueued in a vector floating-point instruction input queue to be sent to an execution pipeline within the processor core. In embodiments, the executing occurs out of order (OoO) 152. OoO instruction execution is a technique used in modern processors to improve performance by allowing instructions to be executed in an order different from the one specified by the program, as long as data dependencies and resource availability are maintained. This helps in utilizing processor resources more efficiently, minimizing idle times, and increasing instruction throughput. In exemplary implementations, the processor continuously fetches instructions from memory (or instruction cache) and places them into a queue, typically referred to as the instruction buffer or instruction window. Each fetched instruction is decoded, and the processor determines what the instruction does (e.g., add, load, branch) and what operands (registers or memory locations) are involved. At this point, the instruction can be broken down into micro-operations, depending on the type of instruction. In exemplary implementations, vector instructions, including vector floating-point instructions, are divided into micro-operations. Dependencies for each instruction and/or micro-operation may be analyzed. Instructions that are ready (e.g., their operands are available, and there are no data hazards) can be dispatched to available execution units (such as ALUs, floating-point units, load/store units, etc.) as soon as these units are free. This dispatch can happen out of order, meaning an instruction that appears later in the program might be executed earlier if its dependencies are resolved first, while earlier instructions are waiting for their operands. Similarly, OoO execution can apply to the one or more VFPMs that were created to replace the original vector floating-point instruction. This can provide increased instruction throughput and improved resource utilization, among other benefits.

The flow 100 continues with requiring, by a first VFPM within the one or more VFPMs, a first update 160 to an architectural floating-point flag. The first update can be required to update one or more other flags. The architectural floating-point flag can comprise an architectural register which can collect error data on floating point instructions such as underflow, overflow, NaN, and so on. As a first VFPM executes in a floating-point pipeline, these and other errors can be detected. Any number of floating-point errors resulting from the execution of the first VFPM can be detected. The architectural flag can indicate a floating-point exception or warning condition, such as divide by zero, NaN results, NaN operands, overflow, underflow, denormal numbers, and so on. In one or more exemplary implementations, a bit field comprising multiple bits serves as an architectural flag, in which each bit within the bit field represents a different floating-point error or warning. For example, a first bit within the bit field can represent a divide by zero operation, a second bit within the bit field can represent a square root of a negative number operation, a third bit within the bit field can represent an overflow situation, and so on.

The flow 100 continues with setting the architectural floating-point flag 170. The setting is based on the first update. The first update can require changes to one or more bits within the floating-point flags. These errors can be stored, combined, and sent to the architectural floating-point flags so that software can handle the errors appropriately. The setting occurs after the one or more VFPMs have been committed by the processor core. Recall that the one or more VFPMs were generated to replace a single vector floating-point instruction. Therefore, every VFPM must complete execution and be committed before an update to the floating-point flags can be made. This ensures that software can detect the correct floating point flag setting at the correct time. In embodiments, the setting is based on control status registers 172. Control status registers (CSRs) can establish operating modes such as indexing modes, floating-point modes, and/or other modes. CSRs can enable error tracking modes, such as floating-point errors. Thus, the setting of the architectural floating-point flags can be enabled by a setting in the CSR. The setting can be based on a single bit, a combination of bits, and so on. The CSR can be set by software or hardware.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

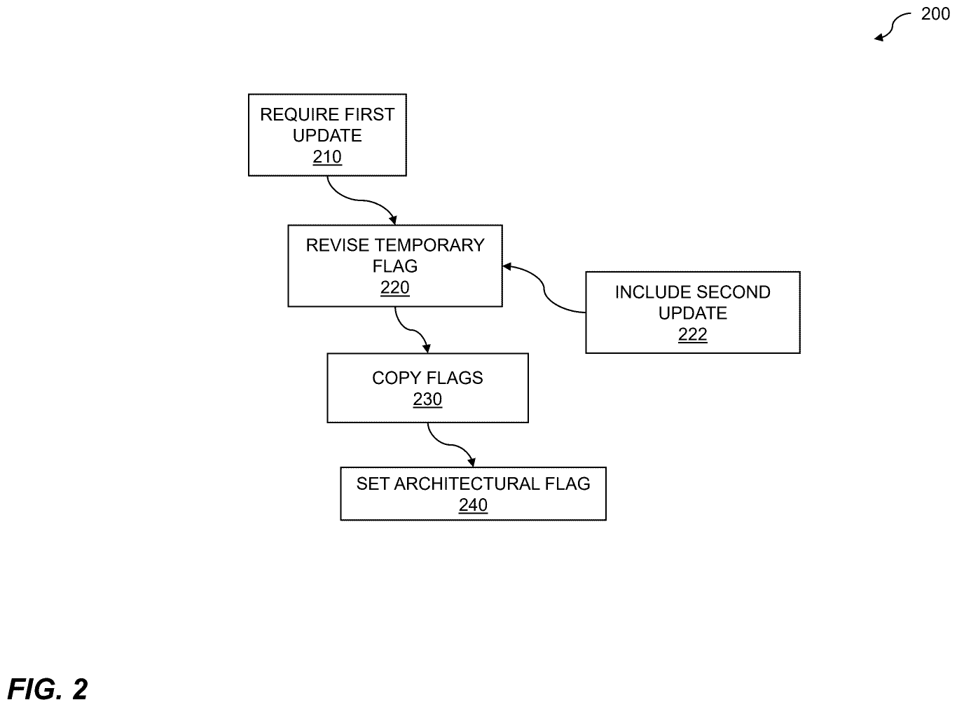

FIG. 2 is a flow diagram for updating flags. The flow 200 includes requiring a first update 210. Embodiments include requiring, by a first VFPM within the one or more VFPMs, a first update to an architectural floating-point flag. As described above and throughout, the first update can be required to update one or more other flags. The architectural floating-point flag can comprise an architectural register which can collect error data on floating point instructions such as underflow, overflow, NaN, and so on. As a first VFPM executes in a floating-point pipeline, these and other errors can be detected. Any number of floating-point errors resulting from the execution of the first VFPM can be detected.

The flow 200 can include revising a temporary flag 220. In embodiments, the setting includes revising a temporary floating-point flag, wherein the revising is based on the first update. Recall that one or more VFPMs were generated to replace a single vector floating-point instruction. Therefore, to ensure a correct architectural state, each VFPM must complete execution and be committed before an update to the architectural floating-point flags can be made. This ensures that software can detect the correct floating point flag setting at the correct time. To accomplish this, each VFPM can update a temporary tag when an error condition is encountered. The setting of the temporary flag can include a flag in a register location, a memory location, a buffer, and so on. The temporary flag can indicate the same floating-point exception or warning conditions as the architectural floating-point flags, such as divide by zero, NaN results, NaN operands, overflow, underflow, denormal numbers, and so on.

The flow 200 can further include copying flags 230. In embodiments, the setting includes copying the temporary floating-point flag to the architectural floating-point flag. As described above, when the VFPMs that were generated from the vector floating-point instruction complete and are committed, the architectural flags can be updated. This can be accomplished by copying the temporary flags to the architectural floating-point flags. The temporary flags and the architectural flags can capture the identical error conditions. In some implementations, the temporary flags can capture more information about the execution of the VFPMs and only send a portion of the information to the architectural floating-point flags. For example, many factors about the execution of the VFPMs can be captured, including a number of cycles taken to complete, statistics on rounding, normalization, and so on. The temporary flags can send only the data that is relevant to the architectural floating-point flags, such as error conditions described above.

The flow 200 can include a second update 222. In embodiments, the requiring includes a second update by a second VFPM within the one or more VFPMs. Similar to execution of a first VFPM, the execution of a second VFPM can also cause a floating-point error, exception, etc. This can require a second update to the architectural floating-point flags. When the first VFPM and the second VFPM were generated by the micro sequencer from the same vector floating-point instruction, any errors from the first VFPM and the second VFPM must be combined. Thus, a third VFPM can require a third update, and so on. In embodiments, the revising includes the second update. As described above and throughout, because one or more VFPMs can be generated to replace a single vector floating-point instruction, each of the VFPMs must complete execution and be committed before an update to the architectural floating-point flags can be made. However, each VFPM can cause a floating-point error, exception, etc. that can be reported by the architectural floating-point flags. Thus, as they execute, the VFPMs can update a temporary flag as they encounter errors during execution. The flow 200 includes setting the architectural floating-point flag 240. When all VFPMs from the single vector floating-point instruction have executed and are completed, the temporary flag can be copied into the architectural floating-point flags. This ensures that the proper floating-point errors and/or warnings can be detected by software executing on the processor core as if the single vector floating-point instruction executed without the use of VFPMs.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

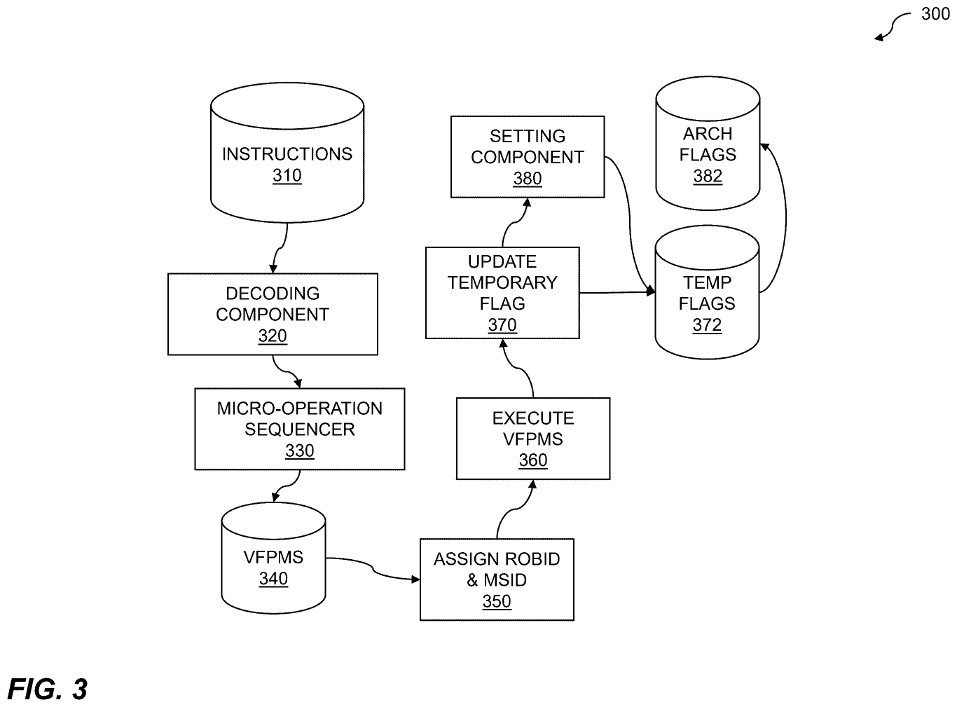

FIG. 3 is an infographic for a vector floating-point flag update with micro-operations. The infographic 300 shows a set of instructions 310. The instructions can be part of a program, process, application, operating system, and so on. The instructions can include scalar instructions, vector instructions, integer instructions, floating-point instructions, branching instructions, and so on. The instructions can be sent to a decoding component 320. The decoding component can include hardware and/or functions for decoding the instructions. The decoding can include determining opcodes, operands, instruction length, dependencies, and/or other instruction decoding tasks. The decode component can decide to replace certain instructions, such as a vector floating-point instruction, with one or more micro-operations. A vector floating-point instruction can be input to micro-operation sequencer 330 to generate micro-operations such as vector floating-point micro-operations (VFPMs) 340. The VFPMs can be input to a reorder buffer (ROB), where they are assigned a ROBID and an MSID 350. In exemplary implementations, each VFPM has its own ROBID, corresponding to a slot within the ROB where the VFPM is temporarily stored prior to VFPM execution. In contrast, each VFPM corresponding to an instruction has a common MSID. In exemplary implementations, the MSID is set to the same value as the latest ROBID corresponding to the vector floating-point instruction. As an example, if a vector floating-point operation is divided into 8 VFPMs, then the ROBID may vary from 4-12, and the MSID for each VFPM may be set to 12. Accordingly, the MSID can serve as a group identifier that can be used for determining which VFPMs are associated with a given vector floating-point instruction. The ROBID allocation can wrap.

Thus, the MSID can be based on a wrap bit to determine the latest ROBID. In this case, the later ROBID can be a lesser value than a ROBID of the other VFPMs. In embodiments, the MSID comprises the ROBID of a last VFPM within the one or more VFPMs.

The VFPMs can then be executed 360 by the processor core. As a result of the execution, temporary flags can be updated at 370 when a floating-point error, exception, etc. is detected. The temporary flags 372 may include bits representing divide by zero, NaN results, NaN operands, underflows, overflows, denormal numbers, and/or other floating-point errors, warnings, exceptions, and/or other information. The setting component 380 can set architectural flags 382 based on the values of temporary flags 372. The setting component 380 can copy the temporary flags 372 to the architectural flags 382 upon committing of each VFPM of the instruction.

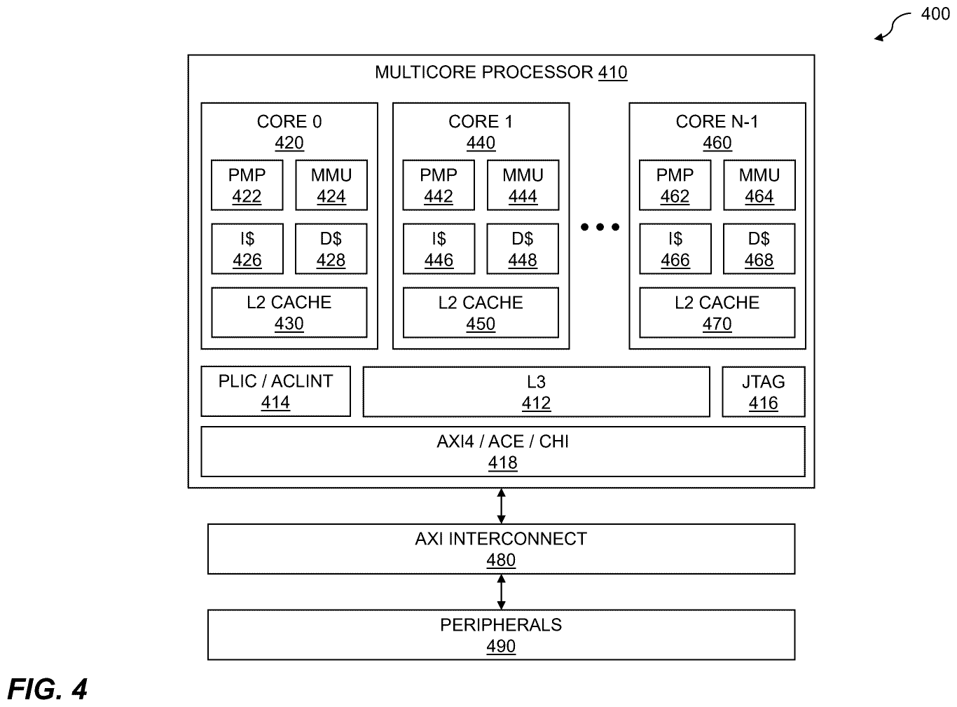

FIG. 4 is a block diagram of a multicore processor. The processor, such as a RISC-V™ processor, ARM processor, or other suitable processor type, can include a variety of elements. The elements can include processor cores including multiprocessor cores, one or more caches, memory protection and management units, local storage, and so on. In one or more exemplary implementations, the processor core enables non-blocking vector instruction dispatch with micro-operations. The elements of the multicore processor can further include one or more of a private cache; a test interface such as a joint test action group (JTAG) test interface; one or more interfaces to a network such as a network-on-chip, shared memory, and peripherals; and the like. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. Execution of the series of micro-operations is initiated. The vector operation is split into a series of micro-operations by a micro-operation sequencer.

In the block diagram 400, the multicore processor 410 can comprise two or more processors, where the two or more processors can include homogeneous processors, heterogeneous processors, etc. In the block diagram, the multicore processor can include N processor cores such as core 0 420, core 1 440, core N-1 460, and so on. Each processor can comprise one or more elements. In one or more implementations, each core, including cores 0 through core N-1, can include a physical memory protection (PMP) element, such as PMP 422 for core 0; PMP 442 for core 1, and PMP 462 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 424 for core 0, MMU 444 for core 1, and MMU 464 for core N-1. The memory management units can translate virtual addresses used by software running on the cores to physical memory addresses with caches, the shared memory system, etc.

The processor cores associated with the multicore processor 410 can include caches such as instruction caches and data caches. The caches, which can comprise level 1 (L1) caches, can include an amount of storage such as 16 KB, 32 KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N-1. In addition to the level 1 instruction and data caches, each core can include a level 2 (L2) cache. The level 2 caches can include L2 cache 430 associated with core 0; L2 cache 450 associated with core 1; and L2 cache 470 associated with core N-1. The cores associated with the multicore processor 410 can include further components or elements. The further elements can include a level 3 (L3) cache 412. The level 3 cache, which can be larger than the level 1 instruction and data caches and the level 2 caches associated with each core, can be shared among all of the cores. The further elements can be shared among the cores. In one or more implementations, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide a boundary within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces such as an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to the interconnect. The interconnect can include a bus, a network, and so on. The interconnect can include an AXI™ interconnect 480. In one or more implementations, the network can include network-on-chip functionality. The AXI™ interconnect can be used to connect memory-mapped “master” or boss devices to one or more “slave” or worker devices. In the block diagram 400, the AXI interconnect can provide connectivity between the multicore processor 410 and one or more peripherals 490. The one or more peripherals can include storage devices, networking devices, and so on. The peripherals can enable communication using the AXI™ interconnect by supporting standards such as AMBA™ version 4, among other standards.

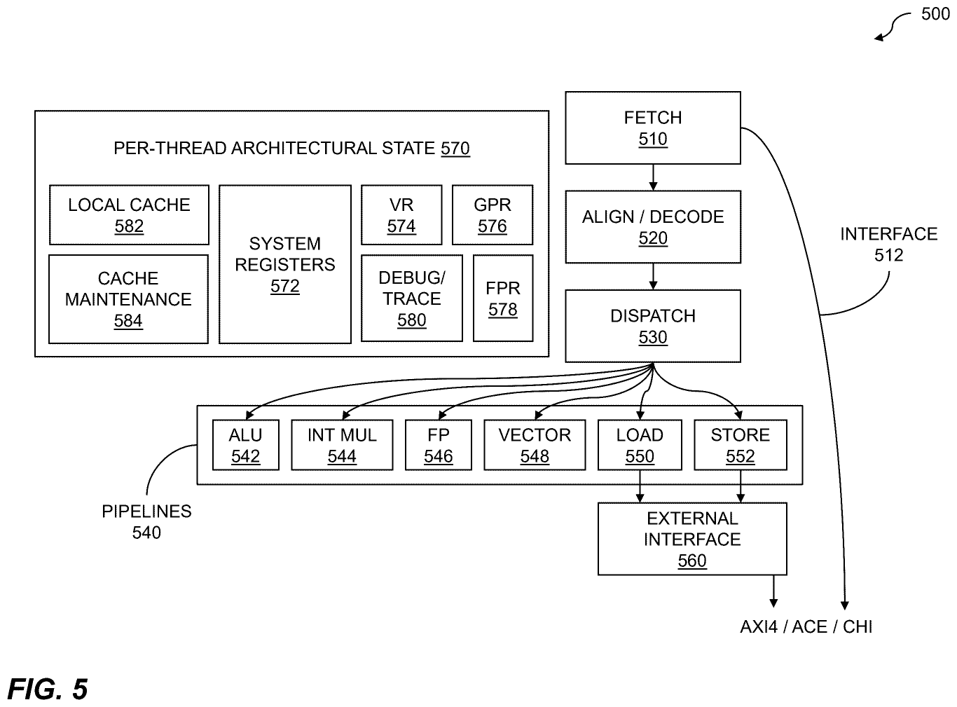

FIG. 5 is a block diagram of a pipeline. The use of one or more pipelines associated with a processor architecture can greatly enhance processing throughput. The processor architecture can be associated with one or more processor cores. The processing throughput can be increased because multiple operations can be executed in parallel. In one or more implementations, a processor core is accessed, where the processor core supports vector operations. The processor core enables non-blocking vector instruction dispatch with micro-operations. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations by a micro-operation sequencer.

The blocks within the block diagram can be configurable in order to provide varying processing levels. The varying processing levels can be based on processing speed, bit lengths, numbers of micro-operations, and so on. The block diagram 500 can include a fetch block 510. The fetch block 510 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 500 can include a dispatch block 530. The dispatch block can receive decoded instruction packets from the align and decode block. The decoded instruction packets can be used to control a pipeline 540, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipelines that can include load pipelines 550 and store pipelines 552. The load pipelines and the store pipelines can access storage such as the common memory using an external interface 560. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 570. The inclusion of the per-thread architectural state can be based on a configuration or architecture that can support multi-threading. In one or more exemplary implementations, thread selection logic can be included in the fetch and dispatch blocks discussed above. Further, when an architecture supports an out-of-order (OoO) pipeline, then a retire component (not shown) can also include thread selection logic. The per-thread architectural state can include system registers 572. The system registers can be associated with individual processors, a system comprising multiple processors, and so on. The system registers can include exception and interrupt components, counters, etc. The per-thread architectural state can include further registers such as vector registers (VR) 574. The vector registers can be grouped in a vector register file and can be used for vector operations. In one or more exemplary implementations, the width of the vector register file is 512 bits. Additional registers, such as general-purpose registers (GPR) 576 and floating-point registers (FPR) 578, can be included. These registers can be used for general purpose (e.g., integer) operations and floating-point operations, respectively. The per-thread architectural state can include a debug and trace block 580. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 582. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 584. The cache maintenance state can include maintenance needed, maintenance pending, and maintenance complete states, etc.

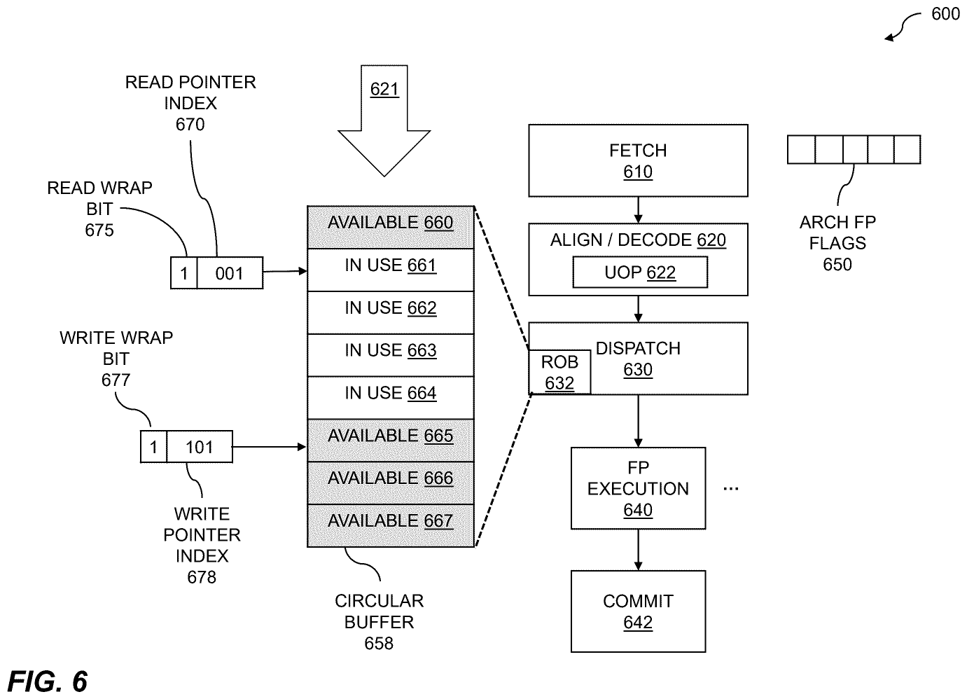

FIG. 6 is a block diagram for a vector floating-point flag update with micro-operations. In the block diagram 600, fetch block 610 can fetch instructions from memory, such as an instruction cache. In one or more examples, the fetch block can be similar to fetch block 510 shown in FIG. 5. Once instructions are fetched, the instructions can be provided to the align/decode unit 620. The align/decode unit may perform functions that include aligning instruction boundaries to ensure proper processing. Additionally, the align/decode unit may perform operations such as translating binary instruction codes into control signals and fields needed for execution, identifying and retrieving operands from registers based on the instruction, and so on. In one or more examples, the align/decode unit may be similar to align/decode block 520 shown in FIG. 5. In one or more examples, the align/decode unit can include micro-operation sequencer 622, which can create one or more micro-operations corresponding to a vector floating-point instruction or another type of instruction.

Once the instructions are decoded, the instructions and/or corresponding micro-operations can be provided to the dispatch unit 630. In one or more examples, the dispatch unit can perform functions that include assigning instructions and/or micro-operations to available execution units based on readiness and resource availability. The dispatch unit can include a reorder buffer (ROB) 632. In one or more examples, the ROB 632 can keep track of the order of instructions and/or micro-operations as they are issued and executed out of order. The ROB can enable proper instruction retirement by ensuring that instructions and/or micro-operations are completed and results are written back in the correct program order. The ROB 632 can include multiple entries, where each entry corresponds to an instruction and/or micro-operation in the dispatch unit. In embodiments, the ROB is within a decode unit.

A reorder buffer identification (ROBID) can refer to an entry in the ROB. In embodiments, the ROB comprises a circular buffer, such as shown at 658. The output of the dispatch unit can be input to floating-point execution unit 640. In exemplary implementations, the floating-point execution unit can include one or more floating-point registers for storing inputs and results. Additionally, the floating-point execution unit may include a control unit, and one or more arithmetic logic units (ALUs) to perform arithmetic operations such as addition, subtraction, multiplication, and division. The floating-point execution unit may further include an exponent module for managing exponent operations. The floating-point execution unit may further include a mantissa module for handling operations on the mantissa and/or significand. The floating-point execution unit may further include a rounding module to ensure that results fit within precision limits using rounding modes. The floating-point execution unit may further include specialized units such as square root or logarithmic units, and the like. The floating-point execution unit may further include an exception handling unit for managing errors and exceptions such as NaN, overflow, underflow, and the like. The output of the floating-point execution unit can be input to a commit stage 642, which can write results to memory and/or registers. Errors detected by the exception handling unit may be copied to the architectural floating-point flags 650 once the commit process completes. Floating-point exceptions from multiple micro-operations may be consolidated prior to setting the architectural floating-point flags.

The reorder buffer (ROB) 632 can be implemented as a circular buffer 658. Circular buffers can provide efficient memory utilization by using a fixed-size array, which simplifies memory allocation and avoids fragmentation. Additionally, circular buffers can enable continuous data storage without wasting memory, as the buffer reuses the space occupied by dequeued elements. The circular buffer can include any number of entries. The dispatch unit can write micro-operations to the ROB and can also read micro-operations from the ROB. Read pointer index 670 can indicate the next entry in the ROB to be read by the dispatch unit. Write pointer index 678 can indicate the next entry in the ROB to be written by the dispatch unit. Once a micro-operation is read, the entry that was read becomes available, and the read pointer index increments to the next location. Similarly, once a micro-operation is written, the entry that was written becomes in use (not available), and the write pointer index increments to the next location. In block diagram 600, there are eight entries in the circular buffer, indicated as locations 660, 661, 662, 663, 664, 665, 666, and 667. In practice, the circular buffer can contain any number of entries. Embodiments include checking, within the ROB, for availability for the one or more VFPMs, wherein the assigning is based on the checking. That is, in some implementations, there must be enough open space in the ROB for all of the VFPMs to be allocated a separate ROBID before any ROBID is assigned to any VFPM. Thus, in embodiments, the availability accommodates each VFPM in the one or more VFPMs. There may be times when there are not enough open entries in the ROB to accommodate all of the VFPMs. In that case, the assigning can stall until space becomes available. Space can become available through the retiring of instructions that are executing in the processor prior to the VFPMs. In embodiments, the availability does not accommodate each VFPM in the one or more VFPMs. Further embodiments include stalling the assigning of the one or more VFPMs.

The read pointer index 670 is shown as currently referencing location 661. Similarly, the write pointer index 678 is shown as referencing location 665. As the read pointer index and write pointer index increment, they move in the direction indicated by arrow 621, towards location 667. Once a read pointer index or write pointer index reaches location 667, the next increment results in a “wrap” back to location 660. One or more implementations may include a wrap bit. In exemplary implementations, a wrap bit may be associated with a read pointer index and/or write pointer index. In block diagram 600, the read pointer index has associated wrap bit 675 and the write pointer index has associated wrap bit 677. The wrap bit(s) can be used to indicate whether a buffer pointer has wrapped around from the end back to the beginning. These bits help in distinguishing between the buffer being full or empty, particularly in cases where the read pointer index and write pointer index are equal. In exemplary implementations, when a read pointer or write pointer wraps back to the top of the circular buffer (location 660), the wrap bit toggles state. Thus, if the wrap bit was ‘0’ before the wrap, it becomes ‘1’ after the wrap. Similarly, if the wrap bit was ‘1’ before the wrap, it becomes ‘0’ after the wrap. In exemplary embodiments, if the read pointer and write pointer are pointing to the same location, and the wrap bit 675 has the same value as wrap bit 677, then the circular buffer 658 is empty. Conversely, if the read pointer and write pointer are pointing to the same location, and the wrap bit 675 has a different value than wrap bit 677, then the circular buffer 658 is full. Thus, in embodiments, the ROB comprises a circular buffer. In further embodiments, the ROB includes a wrap bit. Assessing availability in the ROB enables vector floating-point operations with flag updates. Embodiments can include checking, within the ROB, for availability for the one or more VFPMs, wherein the assigning is based on the checking.

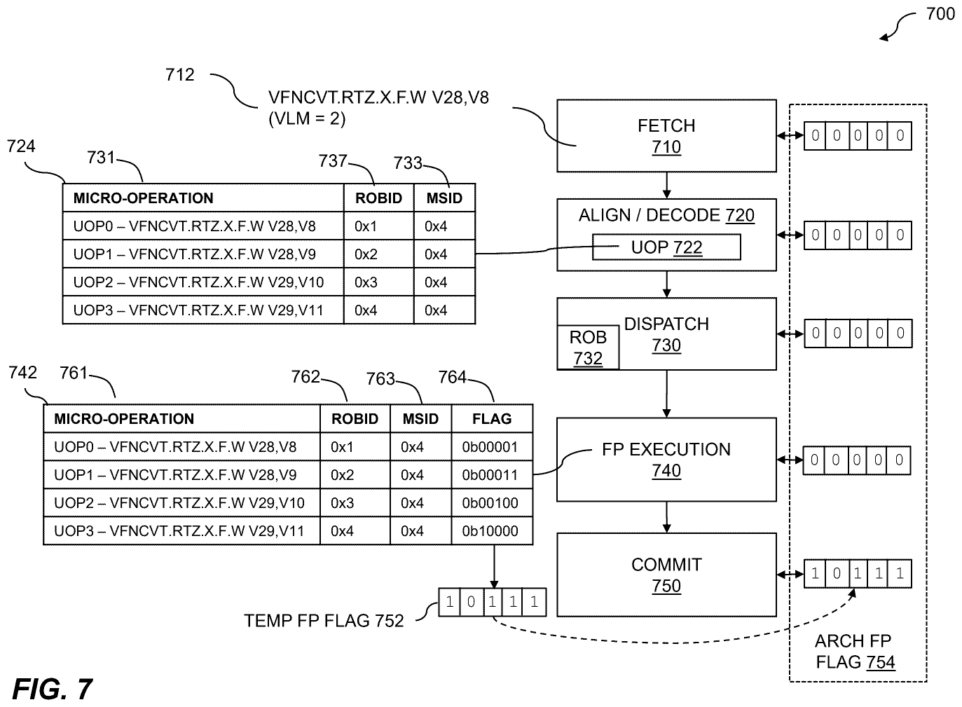

FIG. 7 is an example of copying flag updates. The example 700 depicts setting of vector floating-point flags with micro-operations. The instruction indicated at 712 is a RISC-V architected vector floating point instruction for converting a double-width float number to a signed integer with truncation. The instruction 712 can include a vector length multiplier (VLM) field. The instruction 712 can be fetched by fetch block 710 and provided to align/decode unit 720, which further includes micro-operation sequencer 722. The micro-operation sequencer can create micro-operations corresponding to certain instructions such as the vector floating-point instruction shown. The micro-operations created by micro-operation sequencer are shown in table 724. The micro-operations can comprise vector floating-point micro-operations (VFPMs). In embodiments, the vector floating-point instruction is associated with a vector length multiplier (VLM), wherein each destination register of the one or more VFPMs is based on the VLM.

Table 724 represents the VFPMs prior to their execution. Table 724 includes column 731 which indicates a VFPM. Table 724 further includes column 737 which indicates a ROBID corresponding to each VFPM. In exemplary implementations, the ROBID is indicative of which location within the ROB the micro-operation is stored in. Thus, each VFPM has a unique ROBID. Table 724 further includes column 733 which indicates a micro-sequencer ID (MSID) corresponding to each VFPM. In exemplary implementations, the MSID is set to the highest-valued ROBID among the micro-operations corresponding to a given vector floating-point instruction. In embodiments, the MSID comprises the ROBID of a last VFPM within the one or more VFPMs. In exemplary implementations, the MSID can serve as a group identifier, identifying which instruction a given micro-operation belongs to. The micro-operations in table 724 can be provided to the dispatch unit 730 and loaded in the ROB 732.

The VFPMs are provided to the floating-point execution unit 740 for execution. The floating-point execution unit may be similar to floating-point execution unit 640 shown in FIG. 6. The floating-point execution unit can set one or more bits of a flag. Each bit can be indicative of a particular error, warning, and/or exception that occurs when a floating-point instruction is executed. In exemplary implementations, a first bit can represent a divide by zero condition, a second bit can represent a NaN condition, a third bit can represent an underflow condition, a fourth bit can represent an overflow condition, and a fifth bit can represent a denormal number. Other implementations may have more, fewer, and/or different bits to represent floating-point errors, warnings, and/or exceptions.

Table 742 represents the VFPMs after their execution. Table 742 includes column 761 which indicates a VFPM. Table 742 further includes column 762 which indicates a ROBID corresponding to each VFPM. Table 742 further includes column 763 which indicates a micro-sequencer ID (MSID) corresponding to each VFPM. Table 742 further includes column 764 which includes flag data corresponding to each micro-operation. The flag data can include multiple bits, where each bit represents a particular floating-point error, warning, exception, etc. that occurred as a result of the corresponding micro-operation being executed. As they execute, the VFPMs can save the floating-point error, warning, exception, etc. in a temporary flag.

Referring further to table 742, the micro-operation with a ROBID equal to 1 has a floating-point flag setting of 0b00001, the micro-operation with a ROBID equal to 2 has a floating-point flag setting of 0b00011, the micro-operation with a ROBID equal to 3 has a floating-point flag setting of 0b00100, and the micro-operation with a ROBID equal to 4 has a floating-point flag setting of 0b10000. The flags from each micro-instruction may be logically ORed to set values in temporary flag 752. Thus, for each bit set in temporary flag 752, at least one VFPM resulted in a floating-point condition that caused the bit to be set. Embodiments can include revising a temporary floating-point flag. As a first VFPM is executed, floating-point status bits may be asserted, if exceptions, warnings, and/or errors occur, requiring a first update. In embodiments, the revising is based on the first update. Similarly, as a second VFPM is executed, floating-point status bits may be asserted, if exceptions, warnings, and/or errors occur, requiring a second update. In embodiments, the requiring includes a second update by a second VFPM within the one or more VFPMs. In embodiments, the revising includes the second update.

In the example 700, as no operations have the second most significant bit set, the value of the temporary flag 752 is 0b10111. Thus, the temporary flag 752 serves to consolidate the results from all the micro-operations corresponding to a vector floating-point instruction.

The temporary flag 752 may be updated as vector floating-point micro-operations are processed. The processing of vector floating-point micro-operations can cause an update to temporary floating-point flag 752. After the execution of the VFPMs that took the place of the original vector floating-point instruction completes, the commit stage 750 can write results to memory and/or registers. In exemplary implementations, after the micro-operations have been committed to memory and/or registers by the processor core, the results in the temporary flag 752 are transferred to an architectural floating-point flag 754. The architectural floating-point flag is accessible to software processes so that program code that implements software processes such as device drivers, kernel code, interrupt service routines, and/or user space code can access the architectural flag to determine the status of a vector floating-point instruction. Thus, the low-level implementation details of vector floating-point instruction execution as a set of micro-operations can be hidden from software processes.

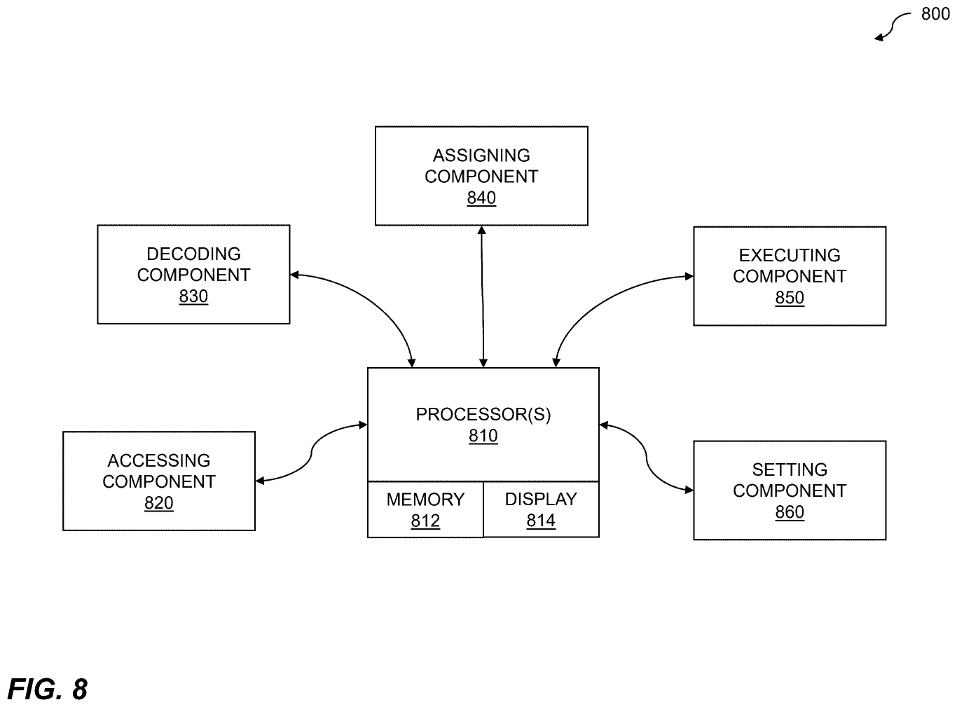

FIG. 8 is a system diagram for a vector floating-point flag update with micro-operations. The system 800 can include instructions and/or functions for design and implementation of integrated circuits that support vector floating-point flag updates with micro-operations. The system 800 can include instructions and/or functions for generation and/or manipulation of design data such as hardware description language (HDL) constructs for specifying structure and operation of an integrated circuit. The system 800 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system 800 can include one or more of processors, memories, cache memories, displays, and so on. The system 800 can include one or more processors 810. The processors can include standalone processors within integrated circuits or chips, processor cores in FPGAs or ASICs, and so on. The one or more processors 810 are coupled to a memory 812, which stores operations. The memory can include one or more of local memory, cache memory, system memory, etc. The system 800 can further include a display 814 coupled to the one or more processors 810. The display 814 can be used for displaying data, instructions, operations, and the like. The operations can include instructions and functions for implementation of integrated circuits, including processor cores. In exemplary implementations, the processor cores can include RISC-V™ processor cores. A system comprising the one or more processors 810, when executing the instructions which are stored in the memory 812, is configured to enable vector floating-point instructions that support flag updates with micro-operations.

The system 800 can include an accessing component 820. The accessing component 820 can include functions and instructions for accessing a processor core, wherein the processor core is coupled to a memory hierarchy, and wherein the processor core is configured to execute vector floating-point instructions and micro-operations. The processor core can include an ARM core, a MIPS core, and/or other suitable core type. In one or more exemplary implementations, the processor core can include a RISC-V architecture. The processor core can support vector operations. The RISC-V architecture can include extensions, where the extensions can enable execution of various arithmetic and logic operations. In exemplary implementations, RISC-V architecture can include vector extensions (RVV). In exemplary implementations, the vector extensions can include vector-floating point instructions, such as vadd.vv to perform element-wise addition of two floating-point vectors, vsub. vv to perform element-wise subtraction of two floating-point vectors, vmul.vv to multiply corresponding elements of two floating-point vectors, vdiv.vv to divide corresponding elements of two floating-point vectors, vfsqrt.v to compute an element-wise square root of each floating-point number in a vector, and other various vector-floating point instructions. Exceptions, errors, and/or warnings can occur when performing vector-floating point operations. Exemplary implementations utilize techniques to consolidate the exceptions, errors, and/or warnings from micro-operations and copy the corresponding flag data to an architectural register.

The system 800 can include a decoding component 830. The decoding component 830 can include functions and instructions for decoding a vector floating-point instruction, wherein the decoding includes replacing the vector floating-point instruction with one or more vector floating-point micro-operations (VFPMs). The vector floating-point instruction can include mathematical operations on two vectors, such as vector addition, as well as single vector instructions, such as performing a square root of every element in a vector, finding a maximum and/or minimum value within a vector, and so on. The VFPMs can replace the vector floating-point instruction as they execute in one or more of the processor core pipelines.

The system 800 can include an assigning component 840. The assigning component 840 can include functions and instructions for assigning, by a reorder buffer (ROB), a reorder buffer ID (ROBID) to each of the one or more VFPMs, wherein the assigning includes a micro-sequencer ID (MSID). In exemplary implementations, a vector floating-point instruction can be divided into any number of vector floating-point micro-operations. In exemplary implementations, the MSID can serve as a group identifier for micro-operations, that can identify multiple micro-operations as belonging to a single high-level vector floating-point instruction. The MSID can be the ROBID of a last VFPM within the one or more VFPMs.

The system 800 can include an executing component 850. The executing component 850 can include functions and instructions for executing, by the processor core, the one or more VFPMs, wherein the executing includes requiring, by a first VFPM within the one or more VFPMs, a first update to an architectural floating-point flag. The first update can include setting one or more bits in a flag, where each bit that is set indicates a particular floating-point exception, error, and/or warning.

The system 800 can include a setting component 860. The setting component 860 can include functions and instructions for setting the architectural floating-point flag, wherein the setting is based on the first update, and wherein the setting occurs after the one or more VFPMs have been committed by the processor core. The setting can include setting one or more bits, where each bit that is set corresponds to a particular floating-point exception, error, and/or warning. In exemplary implementations, the setting is based on the first update. The setting can occur after the one or more VFPMs have been committed by the processor core.

The system 800 can include a computer program product embodied in a non-transitory computer readable medium for instruction execution, the computer program product comprising code which causes one or more processors to generate semiconductor logic for: accessing a processor core, wherein the processor core is coupled to a memory hierarchy, and wherein the processor core is configured to execute vector floating-point instructions and micro-operations; decoding a vector floating-point instruction, wherein the decoding includes replacing the vector floating-point instruction with one or more vector floating-point micro-operations (VFPMs); assigning, by a reorder buffer (ROB), a reorder buffer ID (ROBID) to each of the one or more VFPMs, wherein the assigning includes a micro-sequencer ID (MSID); executing, by the processor core, the one or more VFPMs, wherein the executing includes requiring, by a first VFPM within the one or more VFPMs, a first update to an architectural floating-point flag; and setting the architectural floating-point flag, wherein the setting is based on the first update, and wherein the setting occurs after the one or more VFPMs have been committed by the processor core.

The system 800 can include a computer system for instruction execution comprising: a memory which stores instructions; one or more processors coupled to the memory wherein the one or more processors, when executing the instructions which are stored, are configured to: access a processor core, wherein the processor core is coupled to a memory hierarchy, and wherein the processor core is configured to execute vector floating-point instructions and micro-operations; decode a vector floating-point instruction, wherein the decoding includes replacing the vector floating-point instruction with one or more vector floating-point micro-operations (VFPMs); assign, by a reorder buffer (ROB), a reorder buffer ID (ROBID) to each of the one or more VFPMs, wherein the assigning includes a micro-sequencer ID (MSID); execute, by the processor core, the one or more VFPMs, wherein the executing includes requiring, by a first VFPM within the one or more VFPMs, a first update to an architectural floating-point flag; and set the architectural floating-point flag, wherein the setting is based on the first update, and wherein the setting occurs after the one or more VFPMs have been committed by the processor core.

As can now be appreciated, exemplary implementations enable consolidation and transfer of floating-point status information from individual vector floating-point micro-operations. Floating-point status bits from each micro-operation of a given high-level vector floating-point instruction are identified and consolidated in a temporary storage area. Once the high-level vector floating-point instruction is completed, the corresponding floating point status bits are copied to an architectural flag, where the status of the vector floating-point instruction can be accessed by software executing on the processor core. Hiding low-level implementation details from higher levels in computer processors is a key principle in computer architecture and software design. This concept, often referred to as abstraction, allows different layers of the system to interact without needing to understand the internal complexities of the layers beneath. Disclosed techniques enable hiding of the low-level details of dividing vector floating-point operations into multiple micro-operations from higher-level software processes. This approach can simplify design and development of products, can improve portability and compatibility of software, and also serves to encourage sound design principles of modularity and distinct functional layers. Thus, disclosed implementations enable hardware optimizations, increase maintainability, and boost developer productivity by providing higher-level abstractions, ensuring that systems are scalable and easier to maintain in the long term.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products, processor-implemented methods, and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

1. A processor-implemented method for vector processing comprising:
accessing a processor core, wherein the processor core is coupled to a memory hierarchy, and wherein the processor core is configured to execute vector floating-point instructions and micro-operations;
decoding a vector floating-point instruction, wherein the decoding includes replacing the vector floating-point instruction with one or more vector floating-point micro-operations (VFPMs);
assigning, by a reorder buffer (ROB), a reorder buffer ID (ROBID) to each of the one or more VFPMs, wherein the assigning includes a micro-sequencer ID (MSID);
executing, by the processor core, the one or more VFPMs, wherein the executing includes requiring, by a first VFPM within the one or more VFPMs, a first update to an architectural floating-point flag; and
setting the architectural floating-point flag, wherein the setting is based on the first update, and wherein the setting occurs after the one or more VFPMs have been committed by the processor core.

2. The method of claim 1 wherein the setting includes revising a temporary floating-point flag, wherein the revising is based on the first update.

3. The method of claim 2 wherein the setting includes copying the temporary floating-point flag to the architectural floating-point flag.

4. The method of claim 3 wherein the requiring includes a second update by a second VFPM within the one or more VFPMs.

5. The method of claim 4 wherein the revising includes the second update.

6. The method of claim 1 further comprising checking, within the ROB, for availability for the one or more VFPMs, wherein the assigning is based on the checking.

7. The method of claim 6 wherein the ROB comprises a circular buffer.

8. The method of claim 7 wherein the ROB includes a wrap bit.

9. The method of claim 6 wherein the availability accommodates each VFPM in the one or more VFPMs.

10. The method of claim 6 wherein the availability does not accommodate each VFPM in the one or more VFPMs.

11. The method of claim 10 further comprising stalling the assigning of the one or more VFPMs.

12. The method of claim 1 wherein the MSID comprises the ROBID of a last VFPM within the one or more VFPMs.

13. The method of claim 1 wherein the vector floating-point instruction is associated with a vector length multiplier (VLM).

14. The method of claim 13 wherein each destination register of the one or more VFPMs is based on the VLM.

15. The method of claim 14 wherein the replacing is based on the one or more destination registers.

16. The method of claim 1 wherein the ROB is within a decode unit.

17. The method of claim 1 wherein the executing occurs out of order.

18. The method of claim 1 wherein the replacing is accomplished by a micro-operation sequencer.

19. The method of claim 1 wherein the setting is based on one or more control status registers (CSRs).

20. A computer program product embodied in a non-transitory computer readable medium for vector processing, the computer program product comprising code which causes one or more processors to generate semiconductor logic for:
accessing a processor core, wherein the processor core is coupled to a memory hierarchy, and wherein the processor core is configured to execute vector floating-point instructions and micro-operations;
decoding a vector floating-point instruction, wherein the decoding includes replacing the vector floating-point instruction with one or more vector floating-point micro-operations (VFPMs);
assigning, by a reorder buffer (ROB), a reorder buffer ID (ROBID) to each of the one or more VFPMs, wherein the assigning includes a micro-sequencer ID (MSID);
executing, by the processor core, the one or more VFPMs, wherein the executing includes requiring, by a first VFPM within the one or more VFPMs, a first update to an architectural floating-point flag; and
setting the architectural floating-point flag, wherein the setting is based on the first update, and wherein the setting occurs after the one or more VFPMs have been committed by the processor core.

21. A computer system for vector processing comprising:
a memory which stores instructions;
one or more processors coupled to the memory, wherein the one or more processors, when executing the instructions which are stored, are configured to:
access a processor core, wherein the processor core is coupled to a memory hierarchy, and wherein the processor core is configured to execute vector floating-point instructions and micro-operations;
decode a vector floating-point instruction, wherein the decoding includes replacing the vector floating-point instruction with one or more vector floating-point micro-operations (VFPMs);
assign, by a reorder buffer (ROB), a reorder buffer ID (ROBID) to each of the one or more VFPMs, wherein the assigning includes a micro-sequencer ID (MSID);
execute, by the processor core, the one or more VFPMs, wherein the executing includes requiring, by a first VFPM within the one or more VFPMs, a first update to an architectural floating-point flag; and
set the architectural floating-point flag, wherein the setting is based on the first update, and wherein the setting occurs after the one or more VFPMs have been committed by the processor core.
